(19) United States
(12) Patent Application Publication
(10) Pub. No.: US 2015/0278147 A1
(43) Pub. Date: Oct. 1, 2015

(54) SOLID-STATE MEMORY DEVICE WITH PLURALITY OF MEMORY CARDS

(71) Applicant: 2419265 ONTARIO LIMITED, MISSISSAUGA (CA)

(72) Inventor: Carmelo CERRELLI, Mississauga (CA)

(21) Appl. No.: 14/226,239

(22) Filed: Mar. 26, 2014

(51) Int. Cl. G06F 13/40; G06F 13/42

(52) U.S. Cl. CPC G06F 13/4081; G06F 13/4221

(57) ABSTRACT

A solid-state memory device includes a physical connector, a physical interface connected to the physical connector, an interface controller connected to the physical interface, a serial peripheral interface, and a plurality of memory card connectors connected to the serial peripheral interface. Each memory card connector of the plurality of memory card connectors is configured to receive a removable memory card. The device further includes a controller core connected between the interface controller and the serial peripheral interface. The controller core is configured to present to a host connected at the physical connector a single non-volatile storage unit with a total capacity substantially equal to a sum of individual capacities of a plurality of removable memory cards connected to the plurality of memory card connectors.

### FIELD

The present invention relates to electronic devices, more specifically, to electronic memory devices.

### BACKGROUND

The demand for computer memory steadily increases. Modern hard disk drives suffer from a number of problems. Moving parts, such as rotating platters, can render hard disk drives unreliable. Heat generation and noise is also a concern. Solid-state drives have been developed, but many of these lack the low-cost capacity to effectively replace hard disk drives. In addition, some known techniques of collating smaller storage devices suffer from inefficiencies or are prone to data loss events.

### SUMMARY

According to an aspect of the present invention, a solid-state memory device includes a physical connector, a physical interface connected to the physical connector, an interface controller connected to the physical interface, a serial peripheral interface, and a plurality of memory card connectors connected to the serial peripheral interface. Each memory card connector of the plurality of memory card connectors is configured to receive a removable memory card. The device further includes a controller core connected between the interface controller and the serial peripheral interface. The controller core is configured to present to a host connected at the physical connector a single non-volatile storage unit with a total capacity substantially equal to a sum of individual capacities of a plurality of removable memory cards connected to the plurality of memory card connectors.

### BRIEF DESCRIPTION OF THE DRAWINGS

The drawings illustrate, by way of example only, embodiments of the present invention.

FIG. 1 is a perspective diagram of a solid-state memory device according to some embodiments.

FIG. 2 is a perspective diagram of a solid-state memory device according to other embodiments.

FIG. 3 is a block diagram of a solid-state memory device.

FIG. 4 is a block diagram of components of an instruction memory.

FIG. 5 is a block diagram of a file routing table and file systems.

FIGS. 6a-6b are schematic diagrams of a solid-state memory device according to other embodiments.

### DETAILED DESCRIPTION

The present invention is directed to a solid-state memory device that allows a plurality of removable memory cards to emulate a universal serial bus (USB) mass storage device, serial ATA (SATA) hard disk drive, or similar device. This provides the ability to store large amounts of data within a bank of memory cards while retaining the convenience and functionality of known storage devices.

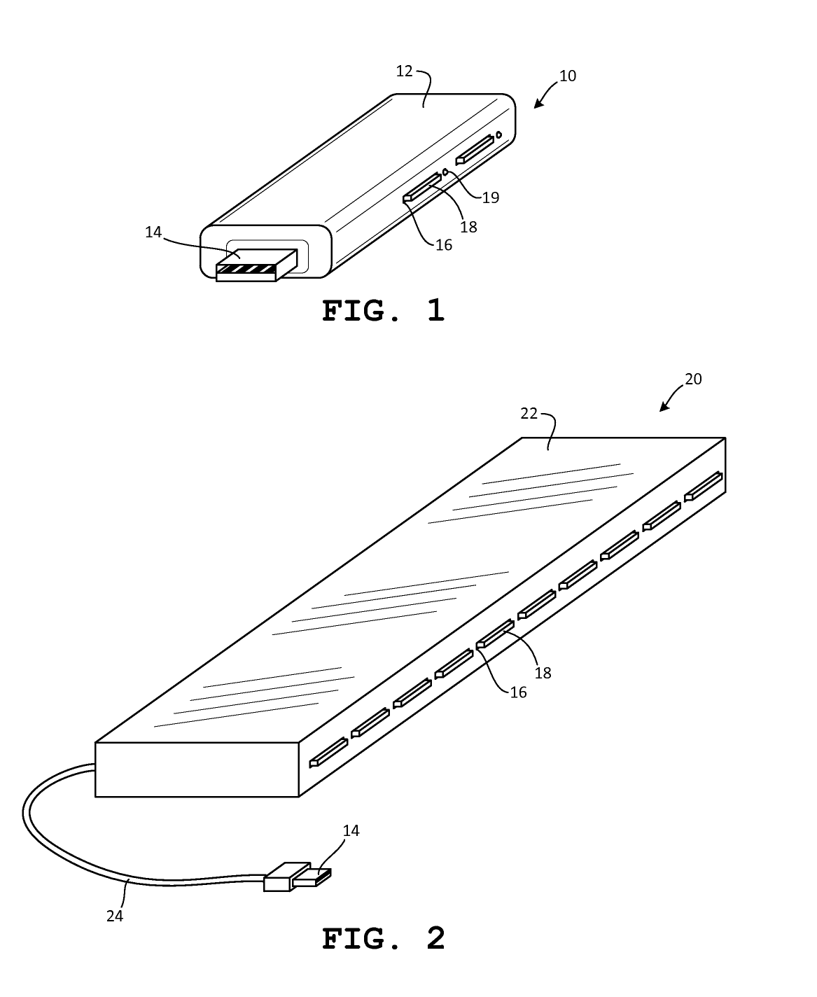

FIG. 1 shows a solid-state memory device 10. The memory device 10 includes a housing 12 having a connector 14, such as a USB Type A plug that protrudes directly from the housing 12 to give the memory device 10 a configuration similar to a portable USB memory stick. The housing 12 further includes openings 16 aligned with a plurality of memory card connectors located inside the housing 12 to allow insertion and removal of a plurality of removable memory cards 18. Indicators 19, such as red and green bi-color status light-emitting diodes (LEDs) can be provided to indicate read/write access and/or faults. Although two openings 16 are shown, any number of openings 16 can be provided to receive any number of removable memory cards 18. The solid-state memory device 10 is portable and can directly plug into any suitable USB host device, such as a computer.

FIG. 2 shows a solid-state memory device 20. Features and aspects of other embodiments described herein can be used with the presently described embodiments, and the description of like-identified components can be referenced. The memory device 20 includes a housing 22 and a connector 14, such as a USB Type A plug that is attached to a circuit board contained inside the housing by a USB cable 24. The housing 22 further includes openings 16 aligned with a plurality of memory card connectors situated inside the housing 22 to allow insertion and removal of a plurality of removable memory cards 18. Status indicators (not shown) may also be provided. Although ten openings 16 are shown, any number of openings 16 can be provided to receive any number of removable memory cards 18. The solid-state memory device 20 can be used as fixed or portable storage, with the cable 24 allowing it to plug into any suitable USB host device, such as a computer.

The removable memory cards 18 may be Secure Digital (SD) cards, miniSD cards, or microSD cards. The storage capacity of such cards can be any available size, such as 16 GB, 64 GB, 128 GB, 1 TB, etc., provided that number of cards and the file system selected supports such.

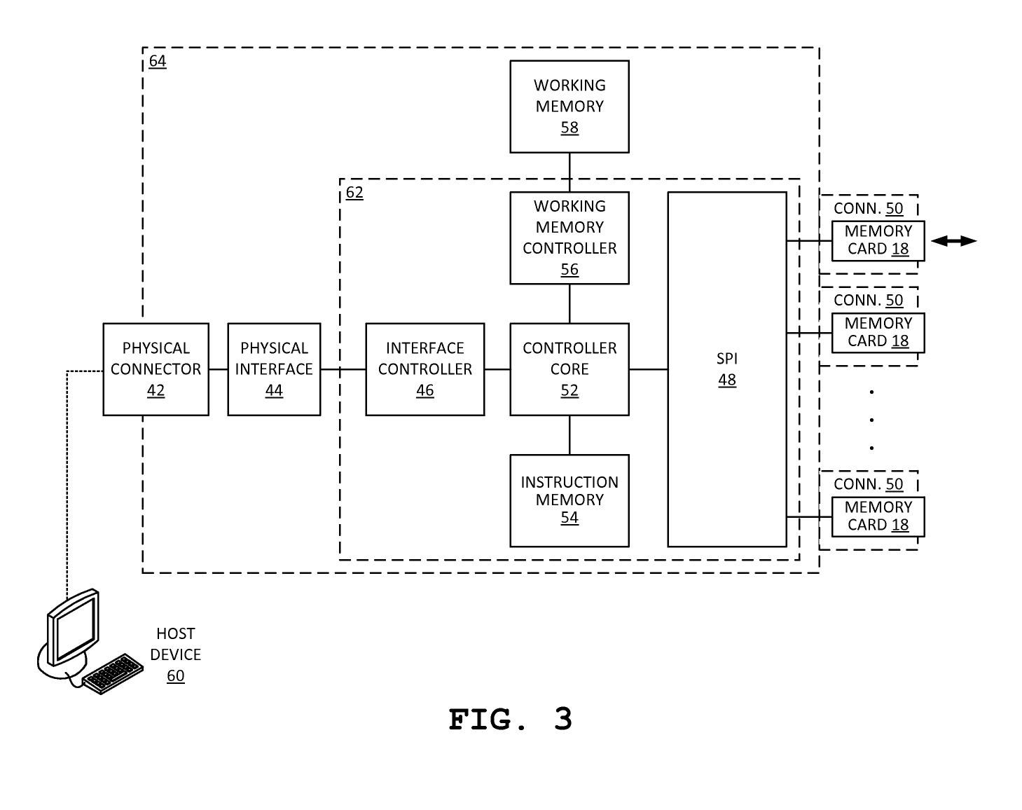

FIG. 3 shows a block diagram of a solid-state memory device, such as the solid-state memory devices 10, 20 of FIGS. 1 and 2 and the device partially shown in FIGS. 6a-6b. The components of the memory device shown in FIG. 3 are examples, and the functionality discussed below can be implemented in other kinds of components, fewer more generalized components, or a greater number of more specialized components.

The solid-state memory device includes a physical connector 42, a physical interface 44 connected to the physical connector 42, an interface controller 46 connected to the physical interface 44, and a serial peripheral interface (SPI) 48. A plurality of memory card connectors 50 are connected to the SPI 48. Each memory card connector 50 is configured to receive a removable memory card 18. The memory device further includes a controller core 52 connected between the interface controller 46 and the serial peripheral interface 48 to manage mass-storage type access to the aggregate capacity of the memory cards 18. The memory device can further include instruction memory 54 connected to the controller core 52, a working memory controller 56 connected to the controller core 52, and working memory 58 connected to the working memory controller 56.

In some embodiments, the physical connector 14 is a universal serial bus (USB) connector that includes a USB Type A plug that is connectable to a USB host device 60, such as a computer. Alternatively, the USB connector 14 can include another type of USB connector or a connector made in accordance with another standard.

In some embodiments, the physical interface 44 is a USB physical interface 44 that is configured to translate digital logic signals between USB controller 46, which operates on 8-bit packets, and the two USB D+ and D− signal lines at the USB connector 42. The USB physical interface 44 can include a high-speed USB transceiver chip, such as those available under the designation USB3319 from Microchip Technology of Chandler, Arizona.

In some embodiments, the interface controller 46 is a USB controller 46 that is configured to transfer data, read/write commands, and handshaking and flow-control communications between the USB physical interface 44 and the controller core 52. The USB controller 46 operates on 8-bit packets.

The USB connector 14, physical interface 44, and controller 46 can be implemented according to the USB 2.0 Specification, USB 3.0 Specification, or similar.

The SPI 48 provides communication between the controller core 52 and the plurality of memory cards 18. In one example, the SPI 48 is configured to translate 32-bit read and write operations from the controller core 52 into 1-bit or 4-bit command and data cycles for the memory cards 18. The SPI 48 can also be connected to indicators 19 (FIG. 1) and control the indicators 19 to illuminate depending on read/write access and/or fault conditions.

The connectors 50 provide physical connections to the removable memory cards 18. The connectors 50 may be off-the-shelf items that allow physical removal and replacement of the removable memory cards 18. However, in some embodiments, the removable memory cards 18 may be locked in place, by for example the shape of the housing or other means, so as to physically prevent removal of memory cards 18.

The controller core 52 is configured to present the removable memory cards 18 to the host 60 as a single non-volatile storage unit with a total capacity substantially equal to the sum of individual capacities of the removable memory cards 18. In some embodiments, the controller core 52 operates on inbound 8-bit packets received from the USB controller 46 and likewise provides outbound 8-bit packets to the USB controller 46 for transmission to the host 60. The controller core 52 is configured to decode and respond to packets received from the host 60, and to communicate data between the host 60 and the plurality of removable memory cards 18. As such, the controller core 52 can be configured to operate the plurality of removable memory cards 18 according to a USB mass storage class device protocol and can thus be implemented to be responsive to any USB status/command/request packets that may be issued by the host 60 when connected to a USB mass storage class device. In other embodiments, such as in a SATA implementation, the controller core 52 operates on packets or other data structures of different size.

The controller core 52 can further be configured to use the working memory 58 as a buffer for data being communicated between the host 60 and the plurality of removable memory cards 18. The controller core 52 can be implemented as a programmable state machine, fixed logic structures, or a combination of such. The controller core 52 can be configured to operate on 32-bit logic.

The instruction memory 54 stores USB enumeration information, a command mapping for commands issuable by the host 60 and to which the controller core 52 is to respond, and one or more file routing tables for the plurality of removable memory cards 18. The instruction memory 54 may further include scratch pad memory for use by the controller core 52. The command mapping may be configured with standard storage access commands that may be requested by the host 60.

The interface controller 46, controller core 52, instruction memory 54, and working memory controller 56, can be implemented in a field-programmable gate array (FPGA) 62, such as a Spartan6 from Xilinx Inc., or as program code executable on a microprocessor.

The working memory controller 56 allows the controller core 52 to access the working memory 58, which the controller core 52 uses as a buffer for data being communicated between the host 60 and the plurality of removable memory cards 18. In this example, the working memory 58 includes 16-bit DDR2 RAM, and the working memory controller 56 is configured to translate 32-bit read and write requests from the controller core 52 into 16-bit data, address, refresh, and control cycles for the working memory 58.

With the optional exception of the physical connector 42, in some embodiments, all of the components of the solid-state memory device can be provided in a multi-layer printed circuit board (PCB) 64 that is enclosed by a housing (e.g., housings 12, 22 of FIGS. 1-2). The physical connector 42 can also be provided on the same PCB 64, as shown in FIG. 1, when the solid-state memory device 10 has USB-key form factor. In other embodiments (FIGS. 2 and 6b), the physical connector 42 can be cable-connected to the PCB 64 to provide a desktop form factor.

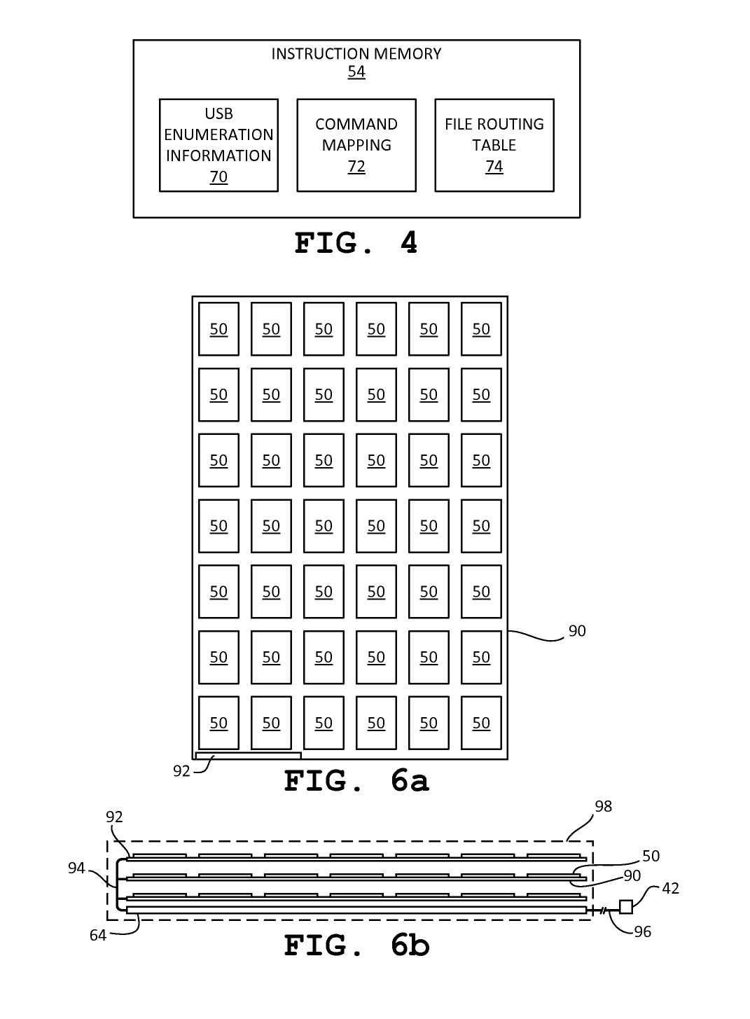

As shown in FIG. 4, in some embodiments, the instruction memory 54 stores USB enumeration information 70. The USB enumeration information 70 includes a device descriptor, configuration descriptor, interface descriptor, and any further information required for the host 60 to perform a USB enumeration sequence.

The instruction memory 54 can further store a command mapping 72. The command mapping maps commands, such as USB or ATA commands, which are expected to be issued by the host 60, to commands, such as ATA commands, that are compatible with the file system used on the memory cards 18.

The instruction memory 54 can further store a file routing table 74.

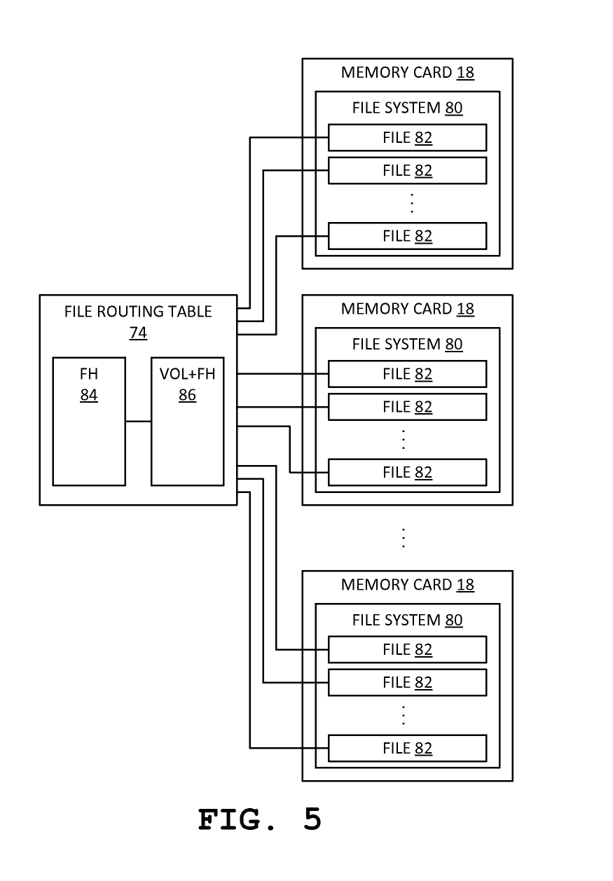

As shown in FIG. 5, each memory card 18 operates under its own dedicated file system 80. In some embodiments, the file system is FAT32. In other embodiments, other file systems can be used, such as NTFS, exFAT, and the like. In some embodiments, each memory card 18 has its own independent file system and can be accessed separately, if removed. The file handles for files 82 in a given memory card 18 are unique, but this is not necessarily so when two or more memory cards 18 are considered.

The file routing table 74 stores information about the memory cards 18 and allows the memory cards 18 to be presented to the host 60 as a single, large storage volume having a total capacity equal to the summed capacities of the memory cards 18. This can be achieved by, for example, the file routing table 74 storing a set of unique, host-facing file handles 84 that maps to a superset of unique volume and file handle pairs 86 of the sets of files handles in the file systems 80. The set of unique file handles 84 is itself configured to abide by a file system, such as FAT32 or similar, which is seen by the host 60 as a single large volume. Thus, the host 60 uses a file handle in the set 84 when accessing a particular file and such host-facing file handle is translated into a volume and file handle pair of the set 86 for access to the correct memory card 18 and the correct file thereon.

The file routing table 74 can be configured to appear as a directory table to the host 60. However, the file routing table 74 replaces structural elements of the directory table, such as starting cluster, file size, etc., with the unique volume and file handle pairs 86 that uniquely identify files in the memory cards 18.

A file handle can be a file name, a file name and extension, or other identifier native to the file system. Collisions between host-facing file handles 84, as may happen when two or more files 82 of different memory cards 18 have the same file name, can be avoided by adding numerical suffixes or similar to the host-facing file handles 84.

Further, in some embodiments, the logic of the file routing table 74 is constrained to completely store a given file in one of the memory cards 18. To achieve this, the file routing table 74, or another table associated therewith, can maintain values representative of the remaining storage capacities of the memory cards 18. Before a new file is written, the controller core 52 can check the file routing table 74 to identify memory cards 18 that each individually have enough space remaining to store the entire file. The controller core 52 then selects one of the memory cards 18 that individually has enough space to store the file. A file is not permitted to span multiple memory cards 18, which can help reduce the chance of data loss, as is found in some kinds of conventional drive spanning techniques, and further can allow for hot-swapping of the memory cards 18 as well as permit their removal for individual use.

When the file routing table 74 is not exactly formatted as a directory table compatible with the file system of the aggregate volume as seen by the host 60, the controller core 52 can be configured to generate a representation of the file routing table 74 that is compatible with such when the host 60 requests access. Such a representation can be generated in real time and can be cached for subsequent use. Hence, additional information, such as memory card free space, may be stored in the file routing table 74 and the controller core 52 can be configured to not provide such information to the host 60 in response to access commands. Alternatively, two or more file routing tables 74 are used, where one such table 74 mimics a directory table for the benefit of the host 60, and the remaining one or more of such tables store other information, such as free space, about the memory cards 18 and files thereon.

The controller core 52 can be configured to re-enumerate and scan the solid-state storage device when a memory card 18 is removed, added, or swapped, so as to validate, create, or delete relationships between the file handles of the sets 84, 86 in the file routing table. Scanning includes the controller core 52 obtaining directories of each of the file systems 80 and creating a unique, host-facing file handle of the set 84 for each file in such directories, if no such file handle exists. Scanning further includes removing file handles from the host-facing set 84 for the volume associated with a memory card 18 that has been removed. When a file on a newly inserted memory card 18 has a file handle that is the same as a file handle on an already present memory card 18, the controller core 52 can be configured to generate an host-facing file handle for one of such files by adding a suffix to a file name (e.g., “my file” and “my file (1)”). The actual file name for such a file is not changed.

In other embodiments, the controller core 52 is configured to operate the plurality of removable memory cards 18 as a redundant array of independent disks (RAID). RAID mirroring can be implemented to allow for data redundancy to help prevent data loss. Any RAID level (e.g., RAID 1, RAID 2, etc.) practical can be used. In some RAID implementations, the memory cards 18 are not swappable as that may corrupt the RAID data. In other embodiments, the controller core 52 is configured to provide data encryption to provide a highly secure and fault tolerant mass storage device.

FIGS. 6a-6b illustrate other embodiments, in which a solid-state memory device is configured to provide a multitude of memory cards within a standard 3.5-inch hard disk housing. Features and aspects of other embodiments described herein can be used with the presently described embodiments, and the description of like-identified components can be referenced. A plurality of memory card connectors 50 is disposed on a substrate 90, such as a PCB. The substrate 90 includes a connector portion 92 for receiving connection of a flex cable 94 to electrically connect the memory card connectors 50 to the flex cable 94. A plurality of memory cards 18 can be coupled to the memory card connectors 50.

Several assemblies of substrate 90, memory card connectors 50, and installed memory cards 18 can be stacked and connected to a PCB 64 having the physical interface 44, the interface controller 46, the serial peripheral interface 48, the controller core 52, the instruction memory 54, the working memory controller 56, and the working memory 58 discussed with respect to FIG. 3. Each substrate 90 is connected to the PCB 64 via one or more flex cables 94. In some embodiments, the solid-state memory device is configured to replace a hard disk drive having a rotating platter. Accordingly, the physical interface 44 is a SATA physical interface, USB 2.0 or USB 3.0 interface, or similar. Similarly, the interface controller 46 is a SATA controller, USB 2.0 or USB 3.0 controller, or similar, and the physical connector 42 is a SATA connector, USB connector, or similar coupled to the PCB via a ribbon cable 96.

The stacked substrates 90 bearing the memory cards 18 together with the controller PCB 64 can be arranged to fit inside the standard volume of a 3.5-inch hard disk. A housing (not shown) may also be provided with standard fastening points to a computer chassis.

The plurality of memory cards 18 may be of the removable kind (e.g., microSD), but need not be user-removable. That is, the arrangement of the substrates 90 and PCB 64 can be permanent or semi-permanent, requiring special tools to access and remove a memory card 18 or preventing any memory card removal altogether.

Advantages of the present invention can include a lack of moving parts, reduced heat generation, reduced noise generation, and low-cost capacity that may effectively replace hard disk drives. In addition, the capacity of a plurality of memory cards is combined in an efficient, user-friendly, and data-safe manner.

While the foregoing provides certain non-limiting example embodiments, it should be understood that combinations, subsets, and variations of the foregoing are contemplated. The monopoly sought is defined by the claims.

What is claimed is:

1. A solid-state memory device comprising:
a physical connector;
a physical interface connected to the physical connector;
an interface controller connected to the physical interface;
a serial peripheral interface;
a plurality of memory card connectors connected to the serial peripheral interface, each memory card connector of the plurality of memory card connectors configured to receive a removable memory card; and
a controller core connected between the interface controller and the serial peripheral interface, the controller core configured to present to a host connected at the physical connector a single non-volatile storage unit with a total capacity substantially equal to a sum of individual capacities of a plurality of removable memory cards connected to the plurality of memory card connectors.

2. The device of claim 1, wherein the physical connector is a universal serial bus (USB) connector, the physical interface is a USB physical interface, and the interface controller is a USB controller.

3. The device of claim 2, wherein the controller core is further configured to decode and respond to USB packets received from the host, and to communicate data between the host and the plurality of removable memory cards.

4. The device of claim 3, wherein the controller core is configured to operate the plurality of removable memory cards according to a USB mass storage class device protocol.

5. The device of claim 4, further comprising instruction memory connected to the controller core, the instruction memory storing USB enumeration information, a command mapping for commands issuable by the host and to which the controller core is to respond, and a file routing table for the plurality of removable memory cards.

6. The device of claim 1, further comprising a file routing table configured to map independent file systems of the plurality of removable memory cards to a file system presented to the host.

7. The device of claim 1, further comprising a working memory controller connected to the controller core and working memory connected to the working memory controller, the controller core further configured to use the working memory as a buffer for data being communicated between the host and the plurality of removable memory cards.

8. The device of claim 1, wherein the controller core is further configured to operate the plurality of removable memory cards as a redundant array of independent disks (RAID).

9. The device of claim 1, further comprising a multi-layer printed circuit board in which are disposed the physical interface, the interface controller, the serial peripheral interface, and the controller core.

10. The device of claim 9, further comprising a housing in which the printed circuit board is enclosed.

11. The device of claim 10, wherein the housing comprises openings aligned with the plurality of memory card connectors to allow insertion and removal of the plurality of removable memory cards.

12. The device of claim 10, wherein the physical connector is attached to the printed circuit board by a cable.

13. The device of claim 1, further comprising the plurality of removable memory cards.

14. The device of claim 13, wherein each of the plurality of removable memory cards is a secure digital (SD) card.

15. The device of claim 1, wherein the physical connector is a serial ATA (SATA) connector, the physical interface is a SATA physical interface, and the interface controller is a SATA controller.

16. The device of claim 1, further comprising a plurality of substrates on which the plurality of memory card connectors are disposed, and a multi-layer printed circuit board in which are disposed the physical interface, the interface controller, the serial peripheral interface, and the controller core, wherein the plurality of substrates and the multi-layer printed circuit board are arranged to fit within a 3.5-inch hard drive housing.

17. The device of claim 16, further comprising the plurality of removable memory cards.
